(19) United States
(12) Patent Application Publication
(10) Pub. No.: US 2025/0361769 A1
(43) Pub. Date: Nov. 27, 2025

(54) SUPPORT SYSTEM FOR AN EXTENDABLE COVERING

(71) Applicant: Blindspace AB, 434 97 KUNGSBACKA (SE)

(72) Inventor: William Wyatt, Bromley Kent (GB)

(73) Assignee: Blindspace AB, 434 97 KUNGSBACKA (SE)

(21) Appl. No.: 18/670,901

(22) Filed: May 22, 2024

(51) Int. Cl. E06B 9/42

(52) U.S. Cl. CPC E06B 9/42

(57) ABSTRACT

A support system for supporting at least one extendable covering includes a bracket and an extendable covering end piece. The bracket is adapted for being connected to a wall or ceiling, wherein the bracket and the extendable covering end piece includes corresponding connection an arrangement for connecting the extendable covering end piece to the bracket in a way that the extendable covering may hang supported by the bracket in a first orientation. The support system includes an adjustment arrangement for fine adjustment of a position of the extendable covering relative to the wall or ceiling to a second orientation. The adjustment arrangement includes an arrangement for locking the extendable covering in the second orientation relative to the wall or ceiling when the extendable covering hangs supported by the bracket.

### BACKGROUND AND SUMMARY

The invention relates to a support system for supporting at least one extendable covering relative to a wall or ceiling.

Extendable coverings are used to cover a window to, for example, manage sunlight, to provide insulation, blackout, to ensure privacy or security, to keep insects out or for purely decorative purposes. Extendable coverings are usually on the interior side of windows, but exterior solutions are also available. Extendable coverings may also be referred to as window furnishings or window blinds. The extendable covering is arranged for movement between a retracted state, in which it is not covering the window, and an extended state, in which it is at least partly covering the window.

One common type of extendable covering comprises a sheet of fabric wound up on a roll, wherein the sheet of fabric may be extended from the roll by a rotation of the roll. More specifically, the extendable covering may be formed by a curtain. Further, there are both motorized and manually operated extendable coverings.

It is known to arrange such a support system in a wall or ceiling adjacent and above a window for supporting the extendable covering. More specifically, such a support system comprises two brackets arranged in a spaced relation, wherein opposite ends of the extendable covering are supported by the brackets. More specifically, the support system may be arranged in a recessed way in the wall or ceiling, wherein the support system may be concealed from view. Further, the extendable covering may be concealed from view when it is in the retracted state inside the recess and only visible when it is arranged in the extended state.

Further, it is known that the support system comprises an elongated support member, such as a headbox, formed by a profile in aluminium, that is adapted to be rigidly connected to the wall or ceiling and extending along a complete extension of the window to be covered, wherein the brackets may be rigidly connected to the elongated support member at either end of the window. The elongated support member may in turn be arranged in a recessed way in the wall or ceiling above the window.

An assembly operation of the extendable covering relative to such an elongated support member that is pre-assembled to the wall or ceiling comprises the step of assembling the brackets to the elongated support member with an accurate spacing corresponding to a length of the extendable covering. Further, the assembly may be cumbersome for an operator in that a weight of the extendable covering must be carried simultaneously with aligning the extendable covering in a desired (normally horizontal) orientation and attaching it to the brackets. For example, sometimes the ceiling is not level or the box has not been installed levelled. Further, when installing the extendable covering, the operator doesn't know until it is installed if it sits perfect, if not he needs to remove the extendable covering, remove the bracket screws and make new holes. Further, the operator may not see until the extendable covering is extended and hangs close to the floor that it needs to be adjusted. Further, using packers to pack out the extendable covering is hassle.

It is desirable to provide a support system that creates conditions for a facilitated assembly, adjustment and securement of an extendable covering relative to a wall or ceiling.

According to an aspect of the invention, a support system is provided for supporting at least one extendable covering, wherein the support system comprises a bracket and an extendable covering end piece, wherein the bracket is adapted for being connected to a wall or ceiling, wherein the bracket and the extendable covering end piece comprises corresponding connection means for connecting the extendable covering end piece to the bracket in a way that the extendable covering may hang supported by the bracket in a first orientation, wherein the support system comprises an adjustment arrangement for fine adjustment of a position of the extendable covering relative to the wall or ceiling to a second orientation and means for locking the extendable covering in the second orientation relative to the wall or ceiling when the extendable covering hangs supported by the bracket.

Accordingly, in assembly, in a first step, the bracket is rigidly attached to the wall in a desired position. The extendable covering end piece is attached at an end of the extendable covering and in a next step, the extendable covering is lifted so that the corresponding connection means of the bracket and the extendable covering end piece engage, wherein the extendable covering will be in the first, preliminary (non-final) orientation, wherein a weight of the extendable covering is carried by the bracket. In a third step, a position of the extendable covering relative to the wall or ceiling is fine adjusted to a second (final) orientation when the extendable covering hangs supported by the bracket. Further, the extendable covering is then locked in the second orientation relative to the wall or ceiling when the extendable covering hangs supported by the bracket.

According to one embodiment example, the adjustment arrangement is arranged to be accessible from below for the fine adjustment when the bracket is connected to the wall or ceiling and the extendable covering end piece is connected to the bracket. The bracket is normally arranged at an upper end of a window, wherein an operator operates from below. Providing the adjustment arrangement to be accessible from below in an assembly step after the extendable covering has been connected to the bracket thereby creates conditions for a facilitated assembly.

According to a further embodiment example, the bracket comprises an inner end that is adapted to be connected to the wall or ceiling and an outer end, wherein the connection means of the bracket is arranged between the inner end and the outer end, and wherein the adjustment arrangement comprises a manually actuatable movable device that is arranged between the connection means of the bracket and the outer end. Accordingly, the extendable covering will extend above the adjustment arrangement in an assembly step after the extendable covering has been connected to the bracket, which creates conditions for proper access to the adjustment arrangement for the operator.

According to a further embodiment example, the locking means comprises a fastener for locking the extendable covering in the second orientation. According to one example, the bracket comprises a plate provided with a hole, wherein the fastener is adapted to engage with the hole. According to one example, the hole has an axis perpendicular to a main plane of the plate. The fastener may be provided with a shaft to be received in the hole and a head that is adapted to be operated by the operator by means of a tool.

According to a further embodiment example, the fastener is adapted for locking the extendable covering in the second orientation by means of a single action being performed. According to one example, the fastener comprises a screw. The hole in the bracket plate may be provided with an internal threading corresponding to an external threading of the screw shaft. Alternatively, the screw is adapted to cut into the material of the plate as it is rotated into the hole. Accordingly, the single action is a rotational movement in this embodiment example.

According to a further embodiment example, the adjustment arrangement comprises a first part that forms a part of the bracket and a second part that forms a part of the extendable covering end piece, wherein the fastener is adapted for locking the first part relative to the second part.

According to a further development of the last-mentioned embodiment example, the first part comprises a first hole configuration and the second part comprises a second hole configuration, wherein the first and second hole configurations are adapted for alignment to provide for a plurality of different relative positions of the extendable covering end piece for the fine adjustment and wherein the fastener is adapted for being engaged in the aligning first and second hole configurations for locking the extendable covering end piece relative to the bracket.

According to a further development of the last-mentioned embodiment example, the first part comprises a first plate adapted for being connected to the wall or ceiling, wherein the first plate comprises the first hole configuration, wherein the second part comprises a second plate adapted for being arranged in parallel with and adjacent the first plate, wherein the second plate comprises the second hole configuration and wherein the second plate is movably arranged relative to the first plate in parallel with an extension plane of the first plate for the fine adjustment when the extendable covering end piece is connected to the bracket in a way that the extendable covering is in the first orientation.

According to one example, the first plate comprises a main body extending in a flat plane and an attachment portion extending in a plane perpendicularly to the extension plane of the main body. The attachment portion is adapted for being attached to the wall or ceiling. The first plate may be formed in a metallic material, such as aluminium.

According to a further development of the last-mentioned embodiment example, the bracket comprises a displaceable portion that is movably arranged relative to the first plate in parallel with the extension plane of the first plate, wherein the displaceable portion comprises the connection means of the bracket and wherein the first and second hole configurations are arranged for alignment to provide for the fine adjustment by displacing the displaceable portion relative to the first plate. According to one example, the displaceable portion is pivotably arranged relative to the first plate in parallel with the extension plane of the first plate.

According to a further development of the last-mentioned embodiment example, the bracket comprises a hole and a pivot pin that is positioned in the hole for allowing pivotability of the extendable covering end piece, wherein at least one of the first and second hole configurations comprises a plurality of spaced holes arranged in a distribution direction for alignment of the first and second hole configurations when pivoting around the pivot pin to provide for the plurality of different relative positions of the extendable covering end piece.

According to one example, the distribution direction of the plurality of spaced holes forms the shape of an arc around the pivot axis. More specifically, the plurality of holes may be arranged with equal spacing along the arc.

By providing the first plate of the bracket with the first hole configuration and arranging the bracket relative to the wall or ceiling so that the first plate extends in a vertical plane, the plurality of holes of the first hole configuration may be distributed in a horizontal direction and perpendicularly to the wall (or a plane of the window). It creates conditions for setting a horizontal position of the end of the extendable covering. Accordingly, a spacing between the extendable covering and the window may be set to a desired distance.

According to a further development of the last-mentioned embodiment example, the hole for the pivot pin is elongated for allowing movement of the extendable covering end piece back and forth and wherein a longitudinal direction of the elongated hole is crosswise relative to the distribution extension of the plurality of spaced holes defined by the at least one of the first hole configurations and the second hole configuration.

According to one example, the elongated hole for the pivot pin has a main extension that provides for it to be in a vertical direction when the bracket is attached to the wall. According to one example, the displaceable portion of the bracket comprises the elongated hole for the pivot pin.

According to a further development of the last-mentioned embodiment example, one of the first hole configuration and the second hole configuration comprises an adjustment recess, wherein the manually actuatable movable device is adapted to simultaneously be in contact with opposite surfaces defining the recess and pivotably arranged relative to the bracket around a pivot axis arranged so that the extendable covering end piece may be moved along the elongated hole when the manually actuatable movable device is rotated.

According to a further embodiment example, the connection means of the bracket is arranged to be accessible for the corresponding connection means of the extendable covering end piece allowing connection of the extendable covering end piece to the bracket by a movement of the extendable covering end piece towards the bracket when the bracket is connected to the wall or ceiling. According to one example, the corresponding connection means of the bracket and the extendable covering end piece are adapted for a click connection. It provides for a facilitated assembly in that the extendable covering being provided with the end piece may be lifted upwards in a single movement for clicking in the end piece to the bracket.

According to a further embodiment example, the support system comprises an elongated support member that is adapted to be rigidly connected to the wall or ceiling, wherein the bracket and the elongated support member comprises corresponding connection means for arranging the bracket in a desired operational position along the elongated support member.

The elongated support member may be formed by a profile in a metallic material such as aluminium, that is adapted to be rigidly connected to the wall or ceiling and have a length extending along a complete extension of the window to be covered. Further, the first plate of the bracket may be formed in a metallic material such as aluminium, wherein the attachment portion of the first plate may be connected to the elongated support member.

According to a further embodiment example, corresponding connection means of the bracket and the elongated support member allows for sliding the bracket along the elongated support member to the desired operational position. It creates conditions for adjusting the bracket to a desired operational position along the elongated support member when the extendable covering hangs in the bracket. It provides for a facilitated assembly.

According to one example, the connection means of the elongated support member is elongated and extends in parallel with a longitudinal direction of the elongated support member. Preferably, the connection means of the elongated support member extends along a complete length of the elongated support member. According to one example, the connection means of the elongated support member comprises two spaced elongated recesses arranged so that they face each other. Further, the connection means of the bracket comprises projections extending in opposite directions that are sized and adapted for being received in the two spaced elongated recesses.

According to a further embodiment example, corresponding connection means of the bracket and the elongated support member allows for twisting the bracket relative to the elongated support member for movement to the operational position. It provides for a facilitated assembly.

According to a further embodiment example, the elongated support member is formed by a headbox, wherein the bracket is adapted to be arranged inside the headbox.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a perspective and exploded view of a support system according to a first embodiment in association with an elongated support member,

FIG. 2 is a perspective view of two brackets in the support system adapted to be connected to the elongated support member in a spaced relationship,

FIGS. 3a, 3b, 3c and 3d disclose, in perspective views, consecutive steps in a sequence for assembly of one of the brackets to the elongated support member,

FIG. 4 is a side view of the bracket firmly connected to the elongated support member,

FIG. 5a is a perspective view of two end pieces for connection to opposite ends of an extendable covering,

FIG. 5b is a perspective view of the two end pieces connected to the extendable covering,

FIG. 6 is a perspective view of the extendable covering provided with the two end pieces for being assembled to the elongated support member provided with the brackets,

FIG. 7 is a perspective partly cut view of the extendable covering in an assembled state relative to the elongated support member,

FIGS. 8a, 8b and 8c disclose, in perspective views, consecutive steps in a sequence for assembly of the end piece to the bracket,

FIGS. 9a, 9b and 9c disclose, in perspective views, consecutive steps in a sequence for fine adjustment of the orientation of the extendable covering relative to the elongated support member,

FIGS. 10a and 10b disclose, in perspective views, an alternative design of an end plate of the extendable covering for attachment to the end piece,

FIGS. 10c and 10d discloss, in perspective views, the extendable covering with the end plate attached to the end piece according to FIG. 10b,

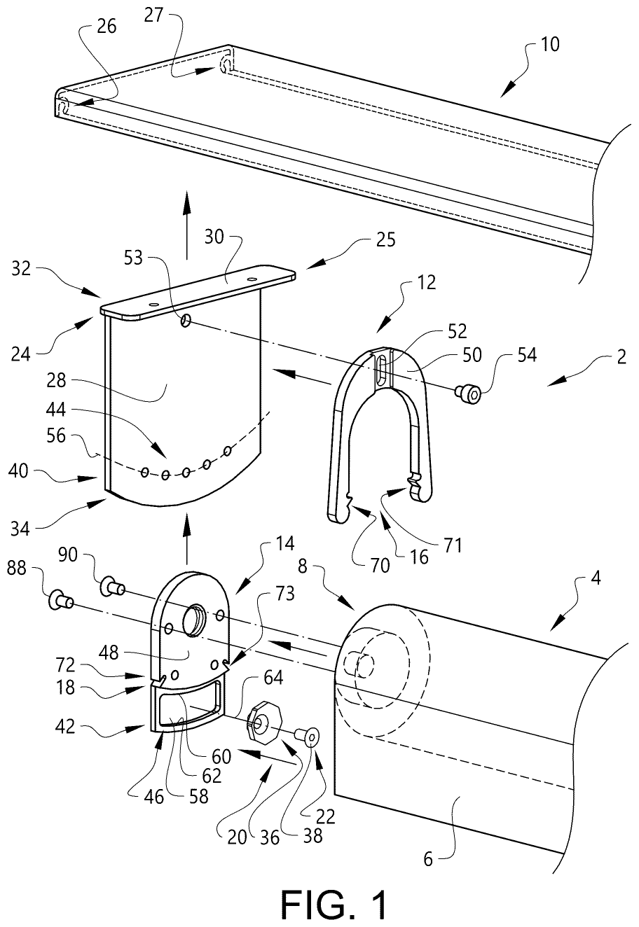

FIGS. 1la and 11b disclose, in perspective views, a further alternative design of an end plate of the extendable covering for attachment to the end piece,

FIGS. 11c and 11d disclose, in perspective views, the extendable covering with the end plate attached to the end piece according to FIG. 11b,

FIGS. 12a and 12b disclose, in perspective views, a further alternative design of an end block of the extendable covering for attachment to the end piece,

FIGS. 12c and 12d disclose, in perspective views, the extendable covering with the end block attached to the end piece according to FIG. 12b,

FIGS. 13a and 13b discloses, in perspective views, an alternative design of the bracket for supporting two adjacent extendable coverings,

FIG. 14a is a perspective and exploded view of a support system according to a second embodiment,

FIG. 14b is a perspective view of the support system in FIG. 14a in an assembled state,

FIG. 14c is a side view of the support system in FIG. 14b,

FIG. 15 is a cross section view of the support system according to the first embodiment in an assembled state recessed in a ceiling,

FIG. 16 is a cross section of the support system according to the first embodiment mounted to an elongated support member in the form of a headbox, and

FIG. 17 is a perspective view of a final installation of the support system according to FIG. 16.

### DETAILED DESCRIPTION

FIG. 1 is a perspective and exploded view of a support system 2 according to a first embodiment. The support system 2 is adapted for supporting at least one extendable covering 4, such as a window covering. The extendable covering 4 is arranged for movement between a retracted state and an extended state for at least partly covering a window (not shown). The extendable covering 4 comprises a sheet of fabric 6 wound up on a roll 8, wherein the sheet of fabric 6 may be extended from the roll by a rotation of the roll.

FIG. 1 further discloses an elongated support member 10 that is adapted to be rigidly connected to a wall or ceiling, such as by means of screws. The elongated support member 10 is plate-shaped and has a main extension in a flat plane. The elongated support member 10 is adapted for extending in a horizontal plane. Further, the elongated support member 10 is straight and may be formed by extrusion. Further, the elongated support member 10 is in a metallic material, such as aluminium. More specifically, the elongated support member 10 may be arranged in a recessed way in the wall or ceiling.

The support system 2 comprises a bracket 12 and an extendable covering end piece 14. The bracket 12 is adapted for being connected to the wall or ceiling by means of the elongated support member 10. More specifically, the bracket 12 is adapted for being directly connected to the elongated support member 10. The bracket 12 and the extendable covering end piece 14 comprises corresponding connection means 16, 18 for connecting the extendable covering end piece 14 to the bracket 12 in a way that the extendable covering 6 may hang supported by the bracket 12.

In an assembly sequence, the extendable covering end piece 14 may first be connected to an end of the roll 8 of the extendable covering 4 and the extendable covering may then be moved towards the bracket 12 so that the corresponding connection means 16, 18 of the bracket 12 and the extendable covering end piece 14 engage, wherein the extendable covering is in a first orientation, that is a non-final orientation.

The support system 2 further comprises an adjustment arrangement 20 for fine adjustment of a position of the extendable covering 4 relative to the wall or ceiling. More specifically, in the assembly sequence, the adjustment arrangement 20 provides for fine adjustment of a position of the extendable covering 4 relative to the wall or ceiling to a second, final orientation from the first non-final orientation. The adjustment arrangement 20 comprises means 22 for locking the extendable covering 4 in the second orientation relative to the wall or ceiling when the extendable covering 4 hangs supported by the bracket 12.

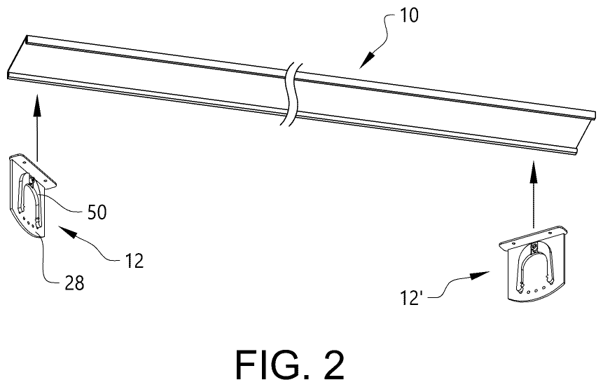

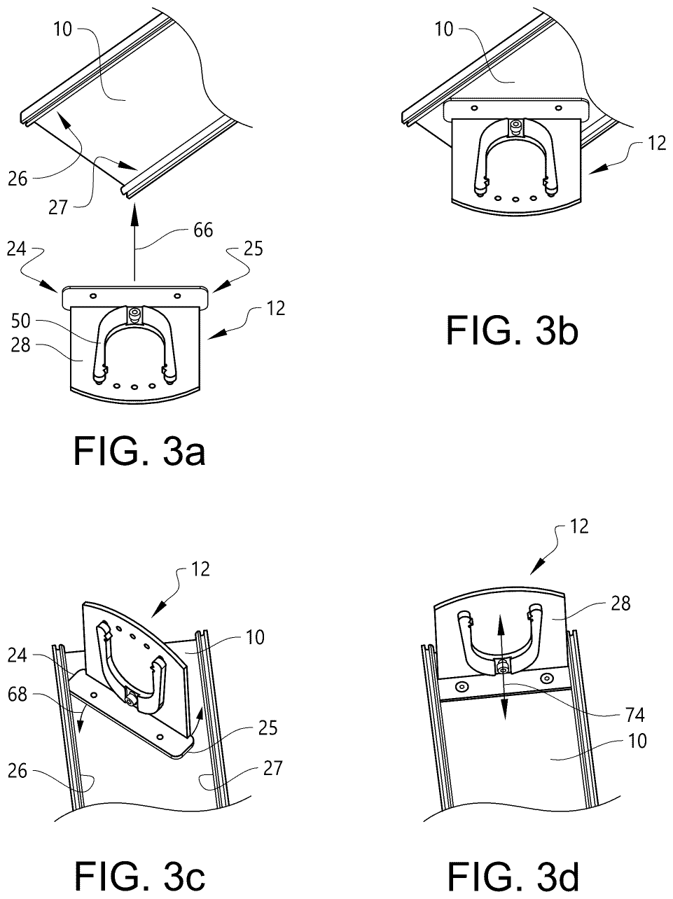

The bracket 12 and the elongated support member 10 comprises corresponding connection means 24, 25, 26, 27 for arranging the bracket 12 in a desired operational position along a longitudinal direction of the elongated support member 10. More specifically, the bracket 10 comprises a first plate 28 adapted for being connected to the elongated support member 10. The first plate 28 comprises a main body extending in a flat plane and an attachment portion 30 extending perpendicularly to the extension plane of the main body. The first plate 28 is formed in a metallic material, such as aluminium. The first plate 28 is formed in a one-piece unit. Opposite projecting ends of the attachment portion 30 in a direction in parallel with the extension plane of the main body forms the connection means 24, 25. The elongated support member 10 comprises two opposite elongated recesses that face each other thereby forming the connection means 26, 27. An assembly of the bracket 12 to the elongated support member 10 will be further described below with reference to FIGS. 2 and 3a-d.

The adjustment arrangement 20 is arranged to be accessible vertically from below for the fine adjustment when the bracket 12 is connected to the wall or ceiling and the extendable covering end piece 14 is connected to the bracket 12.

The bracket 12 comprises an inner end 32 that is adapted to be connected to the elongated support member 10 and an outer end 34. The connection means 24, 25 of the bracket 12 for connection to the elongated support member 10 is arranged adjacent the inner end 32. The outer end 34 defines a free edge of the bracket 12. Further, the connection means 16 of the bracket 12 for connection to the extendable covering end piece 14 is arranged between the inner end 32 and the outer end 34, and wherein the adjustment arrangement 20 comprises a manually actuatable movable device 36 that is arranged between the connection means 16 of the bracket for connection to the extendable covering end piece 14 and the outer end 34.

The manually actuatable movable device 36 comprises the locking means 22. The locking means 22 in turn comprises a fastener 38 for locking the extendable covering 4 in the second orientation. More specifically, the fastener 38 is adapted for locking the extendable covering 4 in the second orientation by means of a single action being performed. More specifically, the fastener 38 comprises a screw, wherein the single action is a rotational movement of the screw, preferably using a screw driver, Allen key or other tool.

The adjustment arrangement 20 comprises a first part 40 that forms a part of the bracket 12 and a second part 42 that forms a part of the extendable covering end piece 14, wherein the fastener 38 is adapted for locking the first part 40 relative to the second part 42. The first part 40 comprises the first plate 28 and comprises a first hole configuration 44 and the second part 42 comprises a second hole configuration 46, wherein the first hole configurations 44 and the second hole configuration 46 are adapted for alignment to provide for a plurality of different relative positions of the extendable covering end piece 14 for the fine adjustment. The fastener 38 is adapted for being engaged in the aligning first and second hole configurations 44, 46 for locking the extendable covering end piece relative to the bracket 12.

The second part 42 comprises a second plate 48 adapted for being arranged in parallel with and adjacent the first plate 28, wherein the second plate 48 comprises the second hole configuration 46. The second plate 48 is movably arranged relative to the first plate 28 in parallel with an extension plane of the main body of the first plate 28 for the fine adjustment when the extendable covering end piece 14 is connected to the bracket 12 in a way that the extendable covering 4 is in the first orientation.

The bracket 12 further comprises a displaceable portion 50 that is movably arranged relative to the first plate 28 in parallel with the extension plane of the main body of the first plate 28, wherein the displaceable portion 50 comprises the connection means 16 of the bracket 12 for connection to the extendable covering end piece 14 and wherein the first and second hole configurations 44, 46 are arranged for alignment to provide for the fine adjustment by displacing the displaceable portion 50 relative to the first plate 28. More specifically, the displaceable portion 50 is pivotably arranged relative to the first plate 28 in parallel with the extension plane of the main body of the first plate 28.

More specifically, the displaceable portion 50 has a U-shape in cross section that is upside down. The connection means 16 of the bracket 12 for connection to the extendable covering end piece 14 comprises a female part defined between the legs of the U-shape of the displaceable portion 50 that is adapted to receive a male part of the corresponding connection means 18 of the extendable covering end piece 14, wherein the male part has a transverse extension corresponding to a spacing between the legs of the U-shape.

More specifically, the connection means 16 of the bracket is arranged to be accessible for the corresponding connection means 18 of the extendable covering end piece 14 allowing connection of the extendable covering end piece 14 to the bracket 12 by a movement of the extendable covering end piece 14 towards the bracket 12 when the bracket 12 is connected to the elongated support member 10. More specifically, the corresponding connection means 16, 18 of the bracket 12 and the extendable covering end piece 14 are adapted for a click connection. More specifically, the legs of the U-shaped displaceable portion 50 are adapted to flex somewhat relative to one another. Further, inner surfaces of the legs of the U-shaped displaceable portion 50 and a corresponding peripheral surface of the extendable covering end piece 14 comprises corresponding projection/recess structures 70, 71, 72, 73 allowing for the click connection.

The bracket 12 further comprises a hole 52 and a pivot pin 54 that is positioned in the hole 54 for allowing pivotability of the extendable covering end piece 14. More specifically, the first plate 28 comprises a further hole 53 and the displaceable portion 50 comprises the hole 54, wherein the displaceable portion 50 is arranged relative the first plate 28 so that the holes 52, 53 are in alignment, wherein the pivot pin 54 is arranged in the two aligning holes and connect the displaceable portion 50 to the first plate 28.

Further, the first hole configuration 44 comprises a plurality of spaced holes arranged in a distribution direction 56. More specifically, the holes in the first hole configuration 44 are arranged spaced from each other along a circular arc with a center point in the further hole 53. Further, the second hole configuration 46 comprises a single hole that is sized to cover a plurality of said holes in the first hole configuration 44. Further, the first hole configuration 44 and the second hole configuration 46 are adapted for alignment when pivoting the displaceable portion 50 around the pivot pin 54 to provide for the plurality of different relative positions of the extendable covering end piece 14. The holes in the first hole configuration 44 provides for different movement regions as the fastener 38 forming a pivot pin is selectably arrangeable in one of the plurality of spaced holes.

More specifically, the first hole configuration 44 is arranged so that the distribution direction 56 of the plurality of spaced holes provides for different operational positions of the extendable covering 4 in a horizontal direction.

More specifically, the hole 52 is elongated for allowing movement of the extendable covering end piece 14 back and forth during assembly. A longitudinal direction of the elongated hole 54 is crosswise relative to the distribution extension 56 of the plurality of spaced holes defined by the first hole configuration 44. More specifically, the longitudinal direction of the elongated hole 54 provides for different operational positions of the extendable covering 4 in a vertical direction.

The second hole configuration 46 comprises an adjustment recess 58, wherein the manually actuatable movable device 36 is adapted to simultaneously be in contact with opposite surfaces 60, 62 defining the recess 58 and pivotably arranged relative to the bracket 12 around a pivot axis 64 arranged so that the extendable covering end piece 14 may be moved along the elongated hole 52 when the manually actuatable movable device 36 is rotated. The pivot axis 64 is commensurate with a rotational axis of the fastener 38.

FIG. 2 is a perspective view of two brackets 12, 12′ in the support system 2 adapted to be connected to the elongated support member 10 in a spaced relationship. The displaceable portion 50 is in a connected state to the first plate 28 by means of the screw 54 so that they may be moved in unison.

FIGS. 3a, 3b, 3c and 3d discloses, in perspective views, consecutive steps in a sequence for assembly of one of the brackets 12 to the elongated support member 10. In FIG. 3a, the bracket 12 is moved, see arrow 66, in an angled orientation relative to a transverse direction perpendicular to a longitudinal direction of the elongated support member 10. In FIG. 3b, the bracket 12 has been moved into contact with a main face of the elongated support member 10. FIG. 3c shows that the corresponding connection means 24, 25, 26, 27 of the bracket 12 and the elongated support member 10 allows for twisting the bracket 12 relative to the elongated support member 10, see arrow 68, for movement to the operational position. FIG. 3d shows the bracket 12 in the final operational position relative to the elongated support member 10, wherein the corresponding connection means 24, 25, 26, 27 of the bracket 12 and the elongated support member 10 are in engagement. Further, the bracket 12 is oriented so that the main extension plane of the main body of the first plate 28 is perpendicular to the longitudinal direction of the elongated support member 10. Further, the corresponding connection means 24, 25, 26, 27 of the bracket 12 and the elongated support member 10 allows for sliding the bracket 12 along the elongated support member 10 to the desired operational position, see arrow 74, when the corresponding connection means 24, 25, 26, 27 are in engagement.

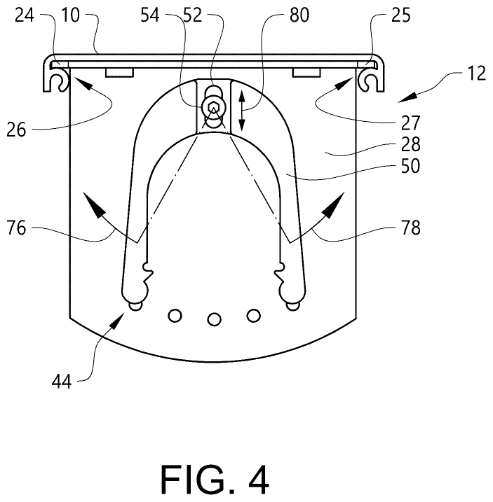

FIG. 4 is a side view of the bracket 12 firmly connected to the elongated support member 10 in an operational state. The arrows 76, 78 indicate a pivoting movement of the displaceable portion 50 relative to the first plate 28 around the pivot pin 54. By means of the pivoting of the displaceable portion 50 relative to the first plate 28, anyone of the holes in the first hole configuration 44 may be selected for receipt of the fastener 38 for orienting the extendable covering 4 horizontally in a desired position. The arrow 80 indicates a linear vertical movement of the displaceable portion 50 relative to the first plate 28 thanks to the elongated design of the hole 52.

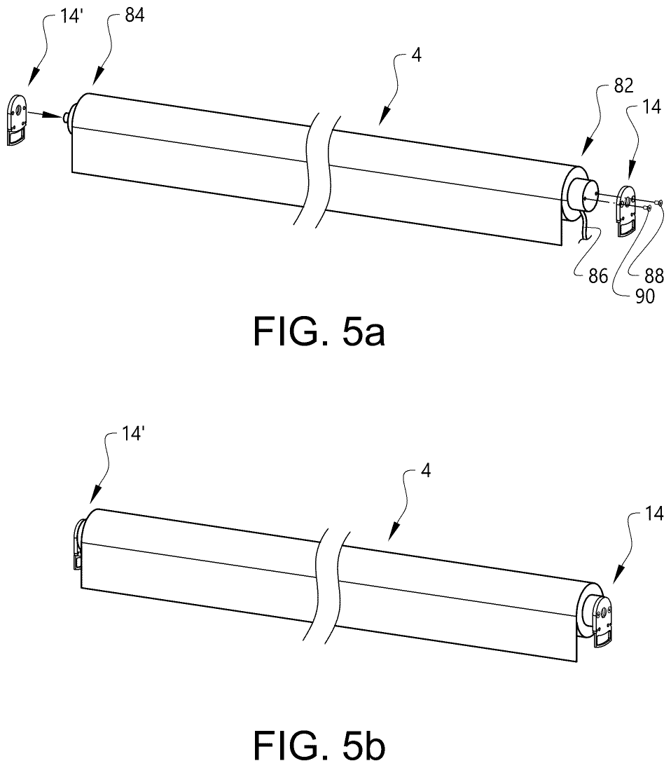

FIG. 5a is a perspective view of two end pieces 14, 14′ for connection to opposite ends 82, 84 of the extendable covering 4. A first end 82 of the extendable covering 4 is a motor end, see cabling 86 for the motor (not shown), and a second end 84 of the extendable covering 4 is an idle end. It may be noted that the extendable covering end piece 14 at the motor end 82 is rigidly attached to the extendable covering 4 by means of two screws 88, 90. It may further be noted that the extendable covering end piece 14′ at the idle end 84 allows for a relative rotational movement, i.e. a bearing function.

FIG. 5b is a perspective view of the two end pieces 14, 14′ connected to the extendable covering 4.

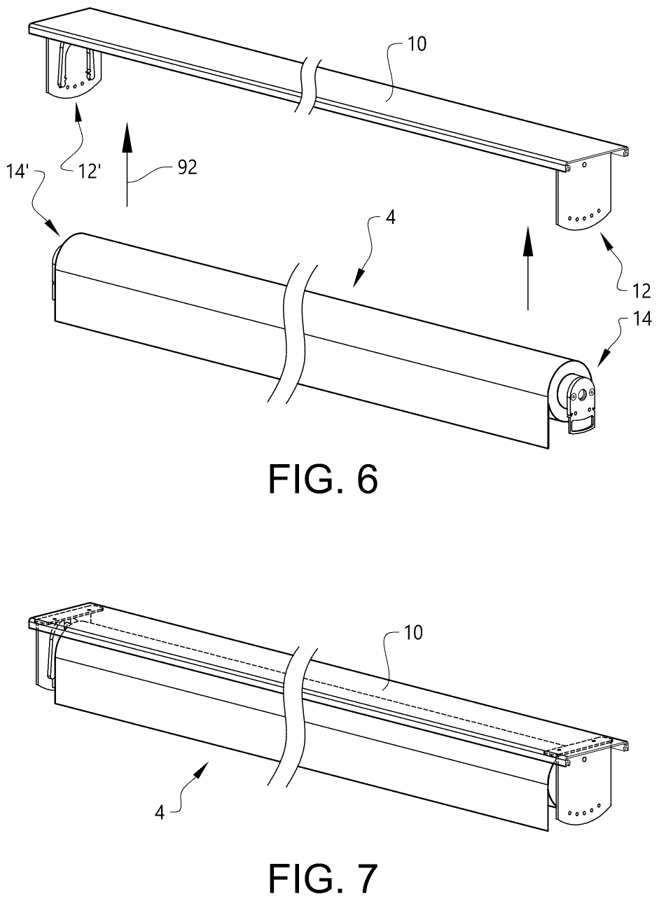

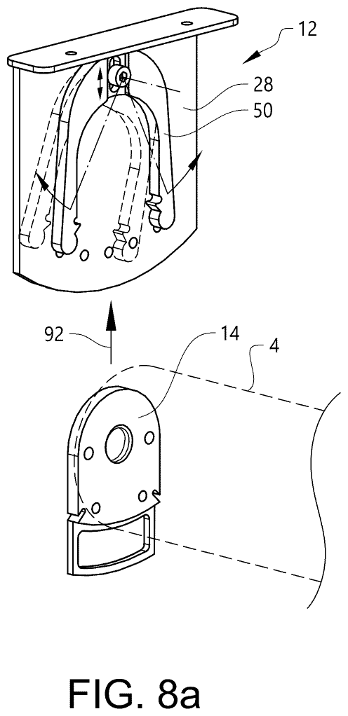

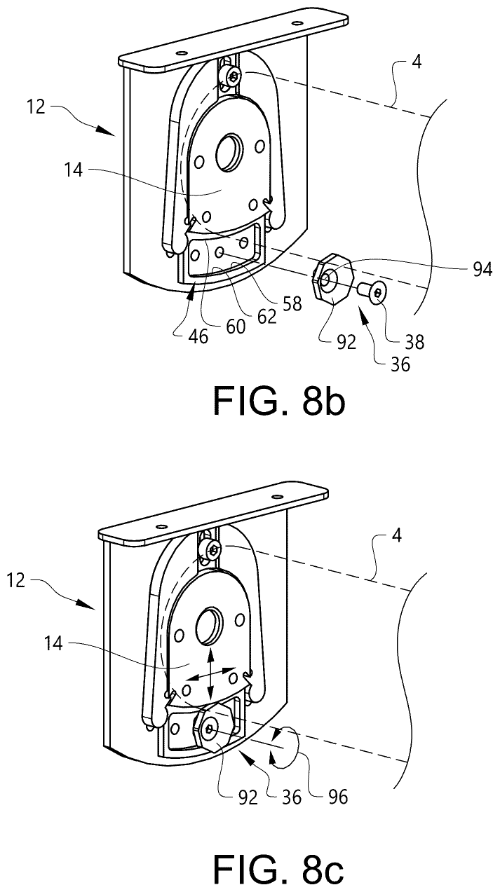

FIG. 6 is a perspective view of the extendable covering 4 provided with the two end pieces 14, 14′ according to FIG. 5b for being assembled to the elongated support member 10 provided with corresponding brackets 12, 12′ according to FIG. 4. More specifically, the elongated support member 10 is rigidly attached to the wall or ceiling in a way that the brackets 12, 12′ are pointing downwards, wherein the female parts of the respective displaceable portion 50 are accessible from below. Further, the extendable covering 4 with the end pieces 14, 14′ attached is moved vertically upwards, see arrow 90 so that the male part of the respective end piece 14, 14′ is moved into engagement with the female part of the respective displaceable portion 50 and connect to the bracket 12 by means of the click connection. It is shown in more detail in FIG. 8a.

FIG. 7 is a perspective partly cut view of the extendable covering 4 in an assembled state relative to the elongated support member 10. In this state, the extendable covering 4 is hanging from the bracket 12 in the first orientation, i.e. the non-final orientation. Accordingly, a weight of the extendable covering 4 is carried by the bracket 12, wherein an operator does not need to carry the weight of the extendable covering as he performs the fine adjustment of the position of the extendable covering.

FIGS. 8b and 8c discloses, in perspective views, steps consecutive to FIG. 8a in a sequence for a fine adjustment of a position of the end piece 14 to the bracket 12 for orienting the extendable covering 4 relative to the bracket 12 from the first orientation to the second orientation, i.e. the final orientation. The manually actuatable movable device 36 comprises the fastener 38 and a manually actuatable pivotably arranged wheel 92. The manually actuatable pivotably arranged wheel 92 is pivotably supported by the fastener 38. More specifically, the wheel 92 comprises a hole 94 for the fastener, wherein the hole 94 is non-centrically arranged in the wheel 92. Further, the wheel 92 is sized to fit in the adjustment recess 58 of the second hole configuration 46, wherein a peripheral surface of the wheel 92 is adapted to simultaneously be in contact with the opposite surfaces 60, 62 defining the recess 58.

In an assembly step, one of the holes in the first hole configuration 46 is selected for an intended sideways (horizontal) position of the extendable covering. The screw 38 is inserted in the hole 94 in the wheel 92 and then further into the selected opening in the first hole configuration 46. The fastener 38 is then pretensioned so that the wheel 92 is in engagement with the adjustment recess 58 of the second hole configuration 46 allowing for rotation of the wheel 92. In a further assembly step, a height of the extendable covering 4 is adjusted by a rotation of the wheel 92 by hand, see arrow 96.

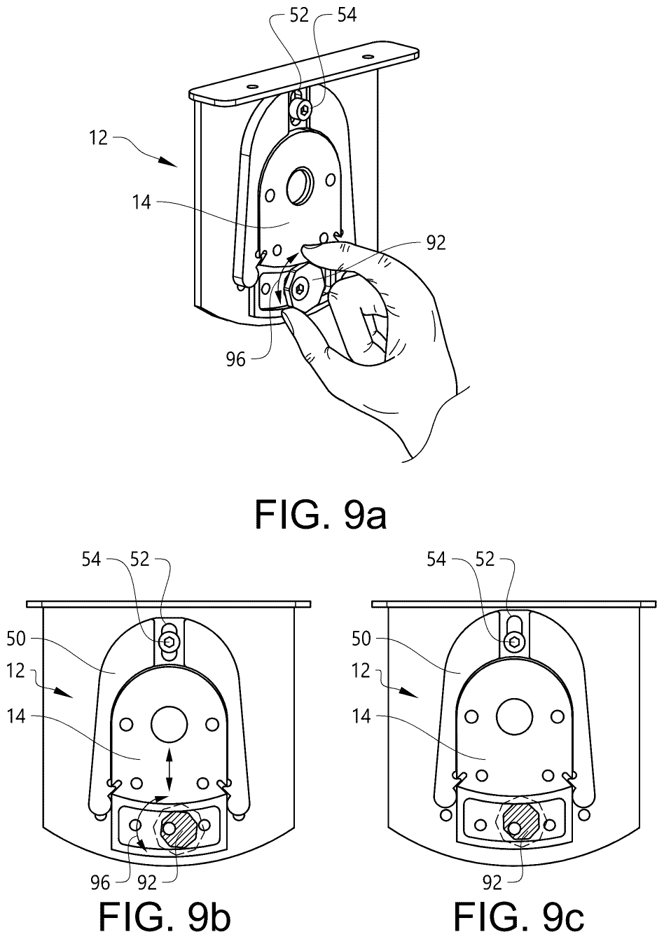

FIGS. 9a, 9b and 9c discloses, in perspective views, consecutive steps in a sequence for fine adjustment of the orientation of the extendable covering 4 relative to the elongated support member 10 and more particularly a height adjustment by rotation of the wheel 92 by hand. It may be noted that a rotation of the wheel 92 may push the end piece 14 and the associated displaceable portion 50 upwards or pull the end piece 14 and the associated displaceable portion 50 downwards thanks to the elongated hole 52 extending vertically.

When a desired vertical position of the extendable covering 4 is reached, the fastener 38 is tightened to lock the extendable covering end piece 14 (and thereby the extendable covering 4) in the desired vertical position.

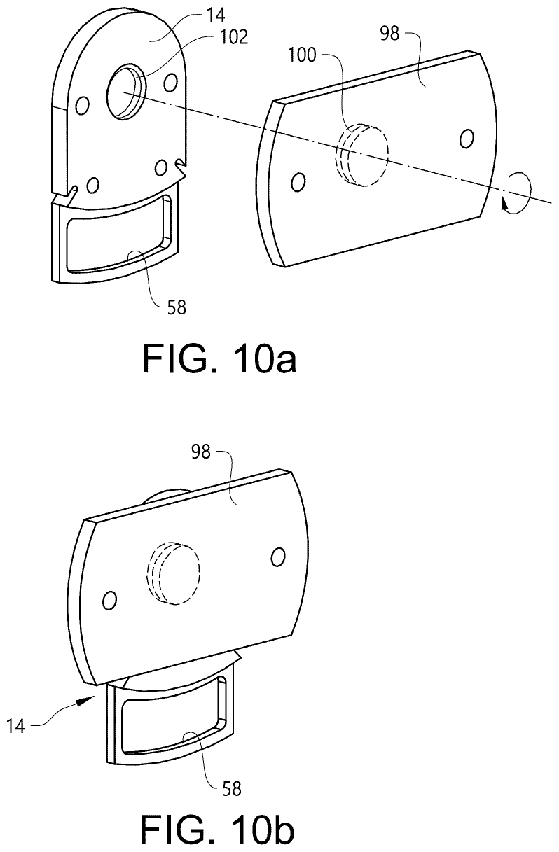

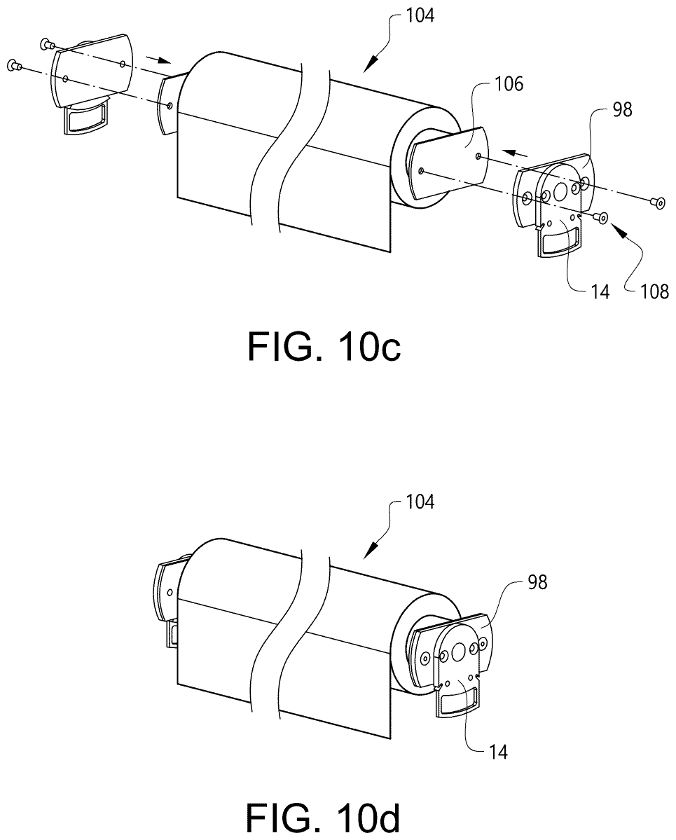

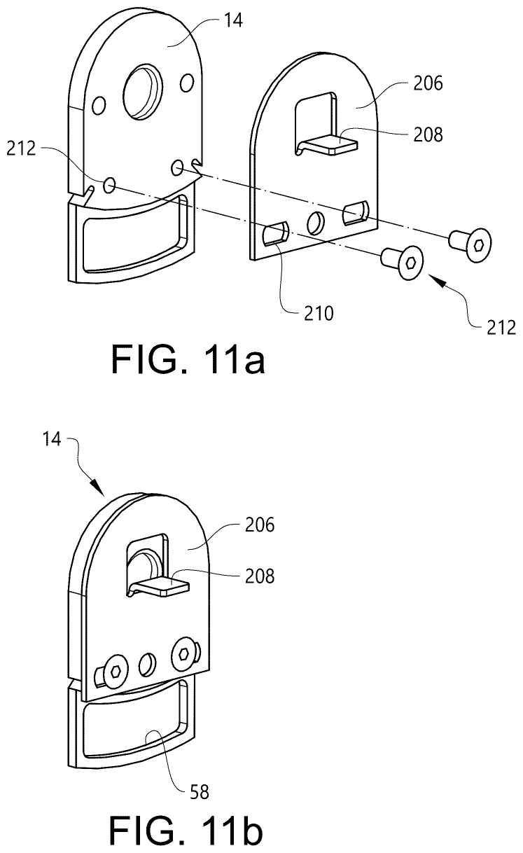

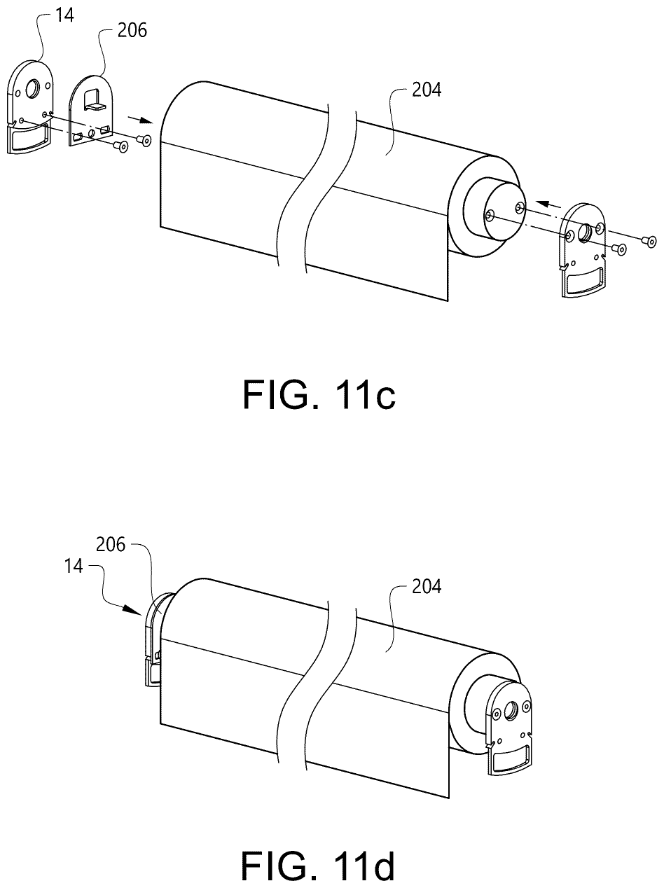

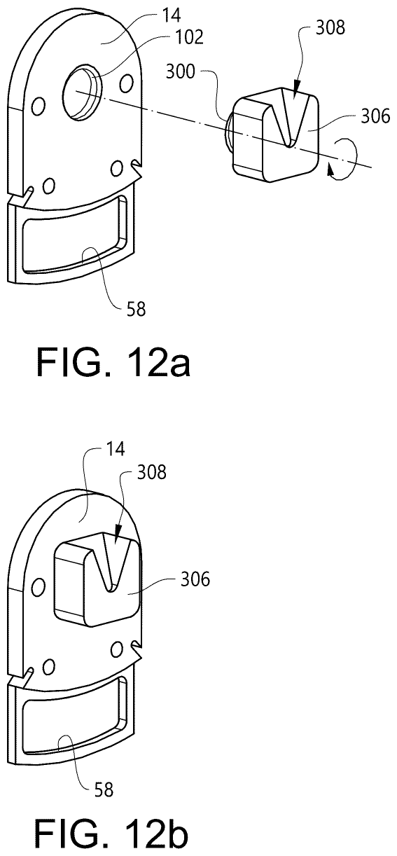

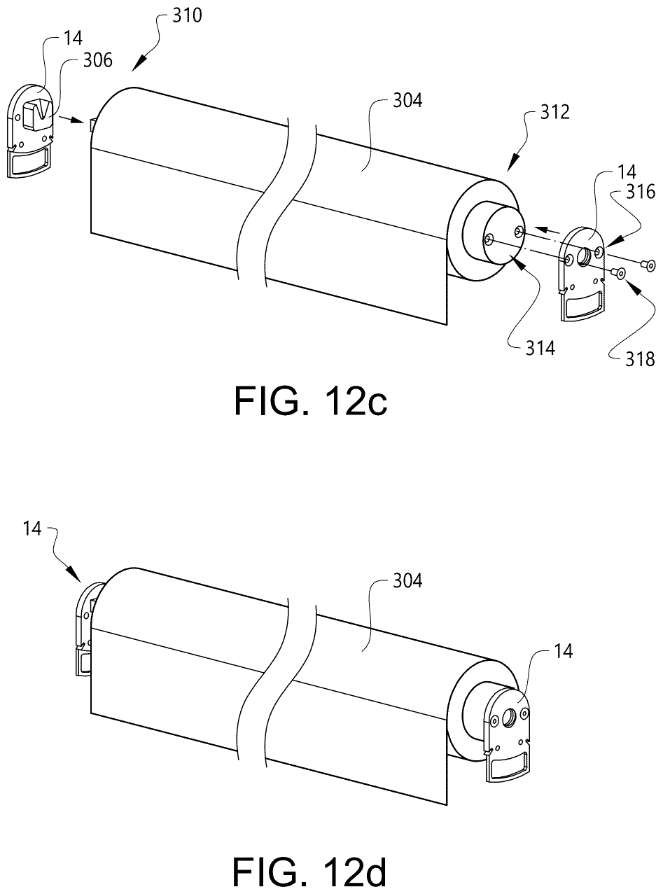

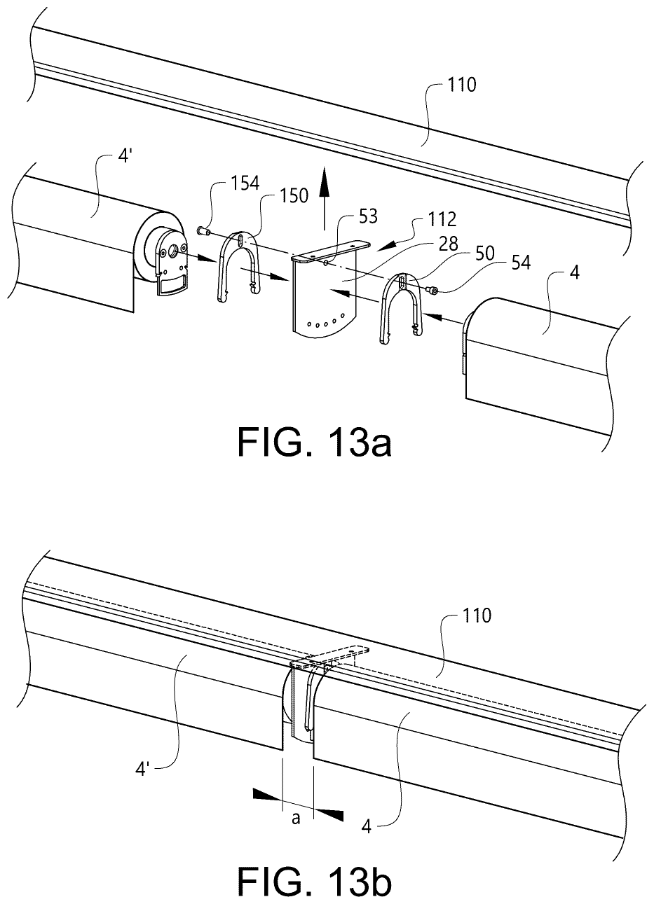

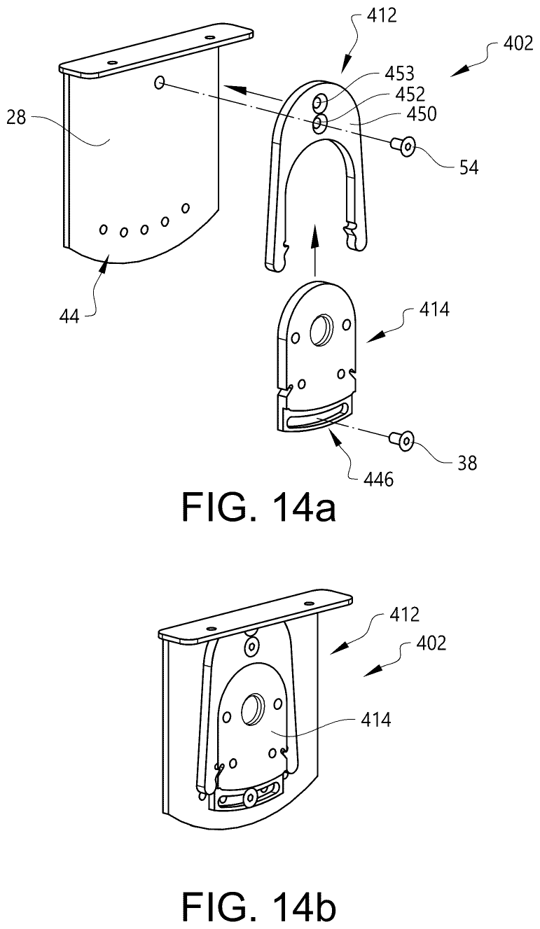

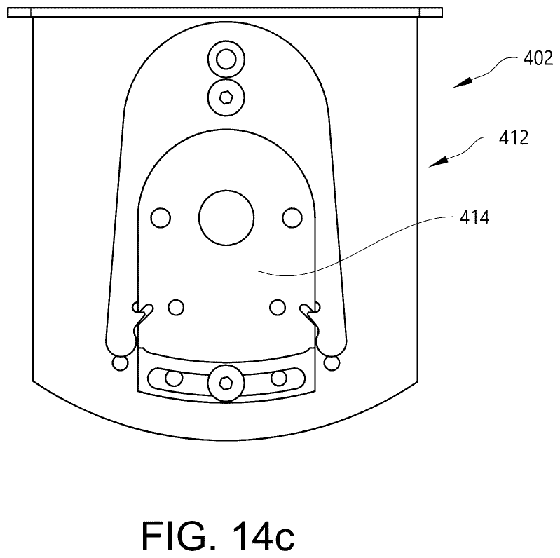

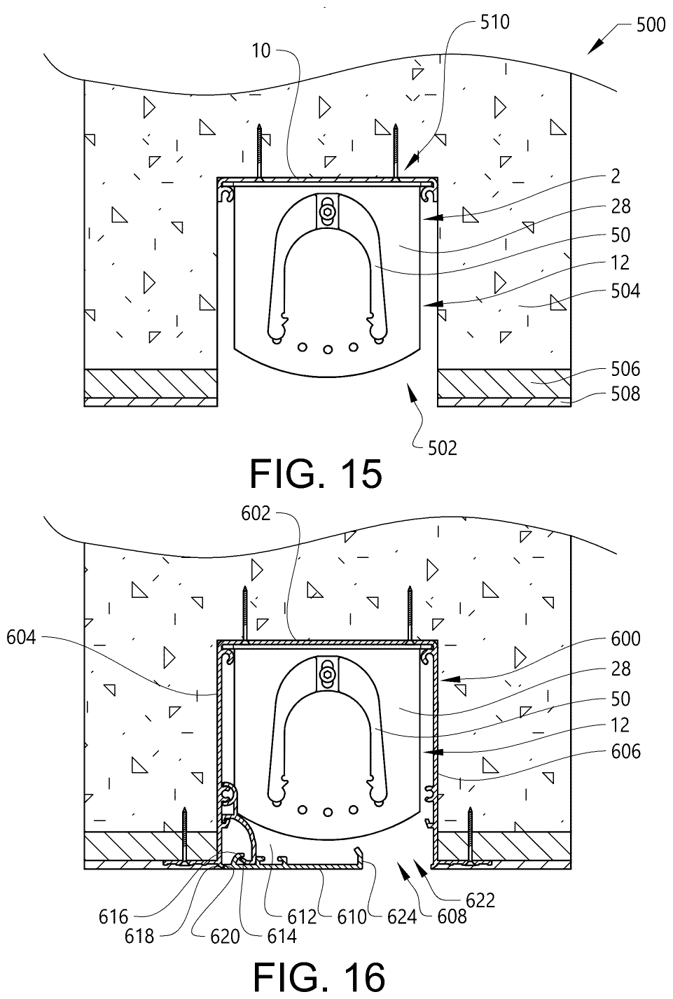

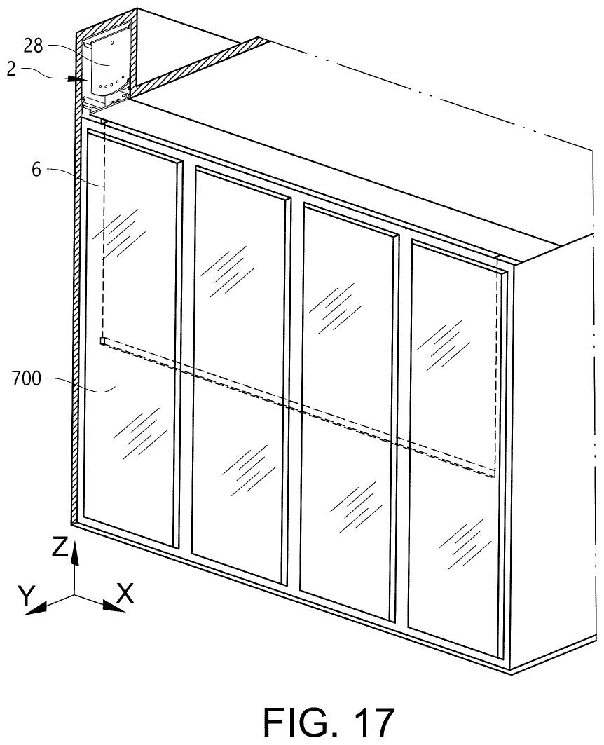

FIGS. 10a and 10b discloses, in perspective views, an alternative design of an end plate 98 associated to an extendable covering 104, see FIG. 10c, of a different design than the extendable covering 4 associated to the first embodiment of the support system 2. The end plate 98 is adapted for attachment to the end piece 14. More specifically, the end plate 98 comprises a threaded projection 100 and the extendable covering end piece 14 comprises a corresponding threaded opening 102 for receipt of the threaded projection 100. In an assembly step, the threaded projection 100 and the corresponding threaded opening 102 are mated and the end plate 98 is rotated relative to the extendable covering end piece 14 until the threading are fully engaged (to the bottom). The threading of the threaded projection 100 and the threaded opening 102 are designed for the end plate 98 to reach a crosswise orientation relative to the extendable covering end piece 14 in the fully engaged state of the threading so that the recess 58 is accessible.

FIGS. 10c and 10d discloses, in perspective views, the extendable covering 104 with the end plate 98 attached to the end piece 14 according to FIG. 10b. The extendable covering 104 is provided with an integral end plate 106 and the end plate 98 associated with the end piece 14 is rigidly connected to the integral end plate 106 by means of a screw connection 108.

FIGS. 11a and 11b discloses, in perspective views, a further alternative design of an end plate 206 of an extendable covering 204, see FIG. 11c, of a different design than the extendable covering 4 associated to the first embodiment of the support system 2. The end plate 206 is adapted for attachment to the end piece 14. The end plate 206 comprises a cut-out and bent portion 208 that is adapted to engage with a correspondingly shaped recess in an end of the extendable covering 204. The end plate 206 further comprises a hole pattern 210 that is adapted for alignment with a corresponding hole pattern 212 in the extendable covering end piece 14. Further, the end plate 206 is adapted to be engaged with the extendable covering end piece 14 by means of a screw connection 212 associated with the hole patterns 210, 212. The extendable covering end piece 14 is designed relative to the end plate 206 so that the recess 58 is accessible after connection to each other. FIGS. 11c and 11d discloses, in perspective views, the extendable covering 204 with the end plate 206 attached to the end piece 14 according to FIG. 11b.

FIGS. 12a and 12b discloses, in perspective views, a further alternative design of an end block 306 associated to an extendable covering 304, see FIG. 12c, of a different design than the extendable covering 4 associated to the first embodiment of the support system 2. The end block 306 is adapted for attachment to the end piece 14. More specifically, the block 306 comprises a threaded projection 300 adapted for mating with the threaded opening 102. The end block 306 comprises a recess 308 for cable routing. The threading of the threaded projection 300 and the threaded opening 102 are designed for the end block 306 to be oriented so that the cable routing recess 308 faces away from the adjustment recess 58, i.e. faces vertically upwards, when fully engaged. The end block 306 is sized so that the recess 58 is accessible when the end block 306 is attached to the end piece 14. FIGS. 12c and 12d discloses, in perspective views, the extendable covering 304 with the end block 306 attached to the end piece 14 according to FIG. 12b for connection to a motor end 310 of the extendable covering 304.

Turning now to an idle end 312 of the extendable covering 304. The idle end 312 of the extendable covering 304 comprises a face with a hole pattern 314. The extendable covering end piece 14 comprises a corresponding hole pattern 316 for alignment with the hole pattern 314. Further, the extendable covering end piece 316 is adapted to be engaged with the window covering end by means of a screw connection 318 associated with the hole patterns 314, 316. The extendable covering end piece 14 is designed relative to the extendable covering 304 so that the recess 58 is accessible after connection to each other.

FIGS. 13a and 13b discloses, in perspective views, an alternative design of a bracket 112 for supporting two adjacent extendable coverings 4, 4′. For ease of presentation, only the main differences relative to the first embodiment of the support system 2 will be described. The bracket 112 comprises a further displaceable portion 150 arranged in a similar fashion as has been described above with regard to the displaceable portion 50 on an opposite side of the first plate 28 relative to the first-mentioned displaceable portion 50. Both displaceable portions 50, 150 are connected to the first plate 28 by means of the same through hole 53. A screw 154 associated to the further displaceable portion 150 is adapted to engage with the hole 53 from an opposite side relative to the screw 54. More specifically, the screw 154 has an axial threaded opening adapted for receipt of the threaded shaft of the screw 54. The arrangement provides for a minimal gap a between the extendable coverings 4, 4′ in the assembled state, see FIG. 13b.

FIG. 14a is a perspective and exploded view of a support system 402 according to a second embodiment. For ease of presentation, only the main differences relative to the first embodiment of the support system 2 will be described. The support system 402 comprises a bracket 412 that in turn comprises a first plate 28 and a displaceable portion 450, wherein the displaceable portion 450 differs from the first embodiment in that the hole 452 for the pivoting function is adapted for a relatively tight fit with the corresponding fastener 54. Accordingly, the support system 402 according to the second embodiment does not provide for a height adjustment (vertical adjustment) after the extendable covering is fitted to the bracket 412. Instead, the displaceable portion 450 comprises a plurality of individual holes 452, 453 spaced in a height direction of the bracket 412, wherein one of the holes 452, 453 is preselected when assembling the bracket 412 before the bracket is attached to the elongated support member 10.

Further, the support system 402 comprises an extendable covering end piece 414 that differs from the extendable covering end piece 14 according to the first embodiment in that the first hole configuration comprises a single elongated hole with a transverse extension in a height direction of the end piece 414 that is substantially commensurate with a height extension of the holes in the first hole configuration 44 of the first plate 28. The single elongated hole has a main extension along an arc, that is overlapping with the arc defined by the plurality of spaced holes in the first plate 28. FIG. 14b is a perspective view of the support system 402 in FIG. 14a in an assembled state, and FIG. 14c is a side view of the support system 402 in FIG. 14b.

As described above, the extendable covering end piece 14, 414 has a design with a plurality of different connection arrangements for connection to different designs of ends of the extendable coverings. Accordingly, a single one of the connection arrangements are used for each application, wherein the other connection arrangements are not used. Accordingly, the extendable covering end piece forms an adapter that adapts the support system for different types of extendable coverings. A single design of the extendable covering end piece creates conditions for a cost-efficient manufacture and distribution.

FIG. 15 is a cross section view of the support system 2 according to the first embodiment in an assembled state recessed in a ceiling 500. More specifically, an elongated groove 502 is formed the ceiling 500, wherein the elongated groove 502 is sized for receipt of the elongated support member 10, the bracket 12 and the extendable covering 4 in the retracted (rolled up) state. The ceiling 500 comprises an inner structure 504, an intermediate layer 506, which may comprise a board, like a plasterboard, and an outermost layer of skim plaster coat 508. The elongated support member 10 is rigidly attached to the ceiling 500 by means of a screw connection 510.

FIG. 16 is a cross section of the support system 2 according to the first embodiment mounted to an elongated support member in the form of a headbox 600. For ease of presentation, only the main differences relative to the elongated support member 10 in FIG. 1, will be described. The headbox 600 comprises an elongated back plate 602 and two spaced elongated side plates 604, 606 extending perpendicularly from the back plate 602 forming a U-shape in cross section. The elongated back plate 602 correspond to the elongated support member 10 as described above. Further, the back plate 602 and the two spaced elongated side plates 604, 606 are formed in a one-piece unit, preferably in an aluminium profile. More specifically, the headbox 600 has a rectangular shape in a cross section, wherein an elongated aperture 608 defines an open side of the rectangle. More specifically, the headbox 600 has a substantially square shape in a cross section. More specifically, the headbox 600 is adapted for accomodating the extendable covering 4 in the retracted state.

An elongated plate shaped cover 610 is adapted to be connected to the headbox 4 in a way that the cover 610 at least partly can conceal an internal space 612 in the headbox 600. The cover 610 is connected to a first one of the side plates 604 of the headbox 600 in a way that it extends in parallel with the back plate 602. The headbox 600 and the cover 610 comprises corresponding pivot means 614, 616 for forming a pivot axis so that the cover 610 may be pivoted between a non-connected state and a connected state in relation to the headbox 600.

Further, the headbox 600 and the cover 610 comprises corresponding engagement means 618, 620 for achieving a click-in function when the cover 610 reaches its operational position in relation to the headbox 600. The cover 610 has a shorter lateral extension relative to the back plate 602 so that a gap 622 is formed between a free edge 624 of the cover 610 and an adjacent surface of the second one of the side plates 606. The extendable covering 4 is arranged to be moved through the gap 622 as it is moved between the retracted state and the extended state.

FIG. 17 is a perspective view of a final installation of the support system 2 according to FIG. 16 in the ceiling for movement between the retracted state and the extended state for at least partly covering a window 700. A coordinate system is indicated, wherein a horizontal direction in parallel with a plane of the window is shown with reference X, a horizontal direction perpendicularly to the plane of the window is shown with reference Y and a vertical direction is shown with reference Z. As has been described above, the support system 2 creates conditions for positioning the roll of extendable covering 4 in a desired position in both the horizontal direction Y perpendicularly to the plane of the window and in the vertical direction is shown with reference Z.

It is to be understood that the present invention is not limited to the embodiments described above and illustrated in the drawings; rather, the skilled person will recognize that many changes and modifications may be made within the scope of the appended claims.

The embodiments above are described in association with an elongated support member that is pre-mounted in the wall or ceiling. According to one alternative, the bracket is directly attached to a structural member of the wall or ceiling, wherein the elongated support member may not be required.

Further, in the embodiments above, the sideways (horizontal) adjustment of the orientation of the extendable covering is achieved by means of a pivoting arrangement, wherein the extendable covering may be set in different positions along an arc-shaped path. According to one alternative, the sideways (horizontal) adjustment of the orientation of the extendable covering may be achieved by means of an arrangement adapted for setting the extendable covering in different positions along linear (horizontal) path.

Further, according to the first embodiment of the support system described above, the orientation of the extendable covering is set in a two step procedure, wherein a sideways (horizontal) adjustment of the orientation of the extendable covering is achieved in a first step followed by a height (vertical) adjustment of the orientation of the extendable covering is achieved in a second step. According to one alternative, the sideways (horizontal) adjustment of the orientation of the extendable covering and the height (vertical) adjustment of the orientation of the extendable covering may be combined in a single operation.

Although the invention has been described above for an extendable covering in the form of a sheet of fabric rolled on a roll, other types include a covering made up of several long horizontal or vertical slats of various types of hard material, including wood, plastic or metal which are held together by cords that run through the blind slats are conceivable.

The invention has above been descried for a case where a single extendable covering is supported by the bracket. According to an alternative, the support system may be adapted so that a plurality of extendable coverings (for different purposes) are supported by the bracket.

According to one example, such a bracket comprises at least two displaceable portions, wherein each one of the displaceable portions is movably arranged relative to the first plate. According to one example, the at least two displaceable portions are arranged at a distance from each other in horizontal direction perpendicular to the window so that any one of the extendable coverings associated to the at least two displaceable portions may be extended/retracted irrespective of the extension state of the other extendable coverings. In other words, the at least two displaceable portions are arranged in a way that any one of the extendable coverings may be operated with no interference with any one of the other extendable coverings.

What is claimed is:

1. A support system for supporting at least one extendable covering, wherein the support system comprises a bracket and an extendable covering end piece, wherein the bracket is adapted for being connected to a wall or ceiling, wherein the bracket and the extendable covering end piece comprises corresponding connection means for connecting the extendable covering end piece to the bracket in a way that the extendable covering may hang supported by the bracket in a first orientation, wherein the support system comprises an adjustment arrangement for fine adjustment of a position of the extendable covering relative to the wall or ceiling to a second orientation and wherein the adjustment arrangement comprises means for locking the extendable covering in the second orientation relative to the wall or ceiling when the extendable covering hangs supported by the bracket.

2. A support system according to claim 1, wherein the adjustment arrangement is arranged to be accessible from below for the fine adjustment when the bracket is connected to the wall or ceiling and the extendable covering end piece is connected to the bracket.

3. A support system according to claim 1, wherein the bracket comprises an inner end that is adapted to be connected to the wall or ceiling and an outer end, wherein the connection means of the bracket is arranged between the inner end and the outer end, and wherein the adjustment arrangement comprises a manually actuatable movable device that is arranged between the connection means of the bracket and the outer end.

4. A support system according to claim 1, wherein the locking means comprises a fastener for locking the extendable covering in the second orientation.

5. A support system according to claim 4, wherein the fastener is adapted for locking the extendable covering in the second orientation by means of a single action being performed.

6. A support system according to claim 4, wherein the fastener comprises a screw.

7. A support system according to claim 4, wherein the adjustment arrangement comprises a first part that forms a part of the bracket and a second part that forms a part of the extendable covering end piece, wherein the fastener is adapted for locking the first part relative to the second part.

8. A support system according to claim 7, wherein the first part comprises a first hole configuration and the second part comprises a second hole configuration, wherein the first and second hole configurations are adapted for alignment to provide for a plurality of different relative positions of the extendable covering end piece for the fine adjustment and wherein the fastener is adapted for being engaged in the aligning first and second hole configurations for locking the extendable covering end piece relative to the bracket.

9. A support system according to claim 8, wherein the first part comprises a first plate adapted for being connected to the wall or ceiling, wherein the first plate comprises the first hole configuration, wherein the second part comprises a second plate adapted for being arranged in parallel with and adjacent the first plate, wherein the second plate comprises the second hole configuration and wherein the second plate is movably arranged relative to the first plate in parallel with an extension plane of the first plate for the fine adjustment when the extendable covering end piece is connected to the bracket in a way that the extendable covering is in the first orientation.

10. A support system according to claim 9, wherein the bracket comprises a displaceable portion that is movably arranged relative to the first plate in parallel with the extension plane of the first plate, wherein the displaceable portion comprises the connection means of the bracket and wherein the first and second hole configurations are arranged for alignment to provide for the fine adjustment by displacing the displacable portion relative to the first plate.

11. A support system according to claim 10, wherein the displaceable portion is pivotably arranged relative to the first plate in parallel with the extension plane of the first plate.

12. A support system according to claim 8, wherein the bracket comprises a hole and a pivot pin that is positioned in the hole for allowing pivotability of the extendable covering end piece, wherein at least one of the first and second hole configurations comprises a plurality of spaced holes arranged in a distribution direction or alignment of the first and second hole configurations when pivoting around the pivot pin to provide for the plurality of different relative positions of the extendable covering end piece.

13. A support system according to claim 12, wherein the hole is elongated for allowing movement of the extendable covering end piece back and forth and wherein a longitudinal direction of the elongated hole is crosswise relative to the distribution extension of the plurality of spaced holes defined by the at least one of the first and second hole configurations.

14. A support system according to claim 3, wherein the hole is elongated for allowing movement of the extendable covering end piece back and forth and wherein a longitudinal direction of the elongated hole is crosswise relative to the distribution extension of the plurality of spaced holes defined by the at least one of the first and second hole configurations, and wherein one of the first hole configuration and the second hole configuration comprises an adjustment recess, wherein the manually actuatable movable device is adapted to simultaneously be in contact with opposite surfaces defining the recess and pivotably arranged relative to the bracket around a pivot axis arranged so that the extendable covering end piece may be moved along the elongated hole when the manually actuatable movable device is rotated.

15. A support system according to claim 1, wherein the connection means of the bracket is arranged to be accessible for the corresponding connection means of the extendable covering end piece allowing connection of the extendable covering end piece to the bracket by a movement of the extendable covering end piece towards the bracket when the bracket is connected to the wall or ceiling.

16. A support system according to claim 1, wherein the corresponding connection means of the bracket and the extendable covering end piece are adapted for a click connection.

17. A support system according to claim 1, wherein the support system comprises an elongated support member that is adapted to be rigidly connected to the wall or ceiling, wherein the bracket and the elongated support member comprises corresponding connection means for arranging the bracket in a desired operational position along the elongated support member.

18. A support system according to claim 17, wherein corresponding connection means of the bracket and the elongated support member allows for sliding the bracket along the elongated support member to the desired operational position.

19. A support system according to claim 17, wherein corresponding connection means of the bracket and the elongated support member allows for twisting the bracket relative to the elongated support member for movement to the operational position.

20. A support system according to claim 17, wherein the elongated support member is formed by a headbox, wherein the bracket is adapted to be arranged inside the headbox.

21. A method for mounting an extendable covering to a wall or ceiling, wherein the method comprises the steps of
connecting a bracket to the wall or ceiling,
connecting an end piece of the extendable covering to the bracket in a single action in a way that the extendable covering hangs supported by the bracket in a first orientation and fine adjusting a position of the extendable covering relative to the wall or ceiling to a second orientation, and
locking the extendable covering in the second orientation relative to the wall or ceiling when the extendable covering hangs supported by the bracket.

22. A method according to claim 21, comprising the step of locking the extendable covering in the second orientation by means of a single fastener by performing a single fastening action.

23. A method according to claim 21, comprising the step of connecting the end piece of the extendable covering to the bracket in the single action by clicking in the end piece to the bracket.
